(19) United States
(12) Patent Application Publication
(10) Pub. No.: US 2009/0109536 A1
(43) Pub. Date: Apr. 30, 2009

(54) PLASTIC OPTICAL ELEMENT WITH GAS BARRIER FILM, ITS MANUFACTURING METHOD AND OPTICAL PICKUP DEVICE EMPLOYING THE ELEMENT

(75) Inventors: Kazuhiro Fukuda, Tokyo (JP); Hiroaki Arita, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA HOLDINGS, INC., Tokyo (JP)

(21) Appl. No.: 12/302,099

(22) PCT Filed: May 28, 2007
(86) PCT No.: PCT/JP2007/060792

§ 371 Date: Nov. 24, 2008

(30) Foreign Application Priority Data
Jun. 2, 2006 (JP) 2006-154405

(51) Int. Cl. G02B 1/10; B29D 11/00

(52) U.S. Cl. 359/580; 264/1.32; 427/458

(57) ABSTRACT

The present invention provides a plastic optical element with excellent durability and an optical pickup device with excellent pickup property. The plastic optical element is an plastic optical element with a gas barrier film comprising a resin substrate and provided thereon, at least one ceramic layer, the residual stress of the ceramic layer being from 0.01 to 100 MPa in terms of compression stress, and a density ratio Y (=ρf/ρb) satisfying the following inequality:

1≧Y>0.95
wherein ρf represents a density of the ceramic layer, and ρb represents a density of a layer which has the same composition ratio as the ceramic layer and which has been formed by thermal oxidation or thermal nitridation of a metal which is a base material of the ceramic layer.

### FIELD OF THE INVENTION

The present invention relates to a plastic optical element capable of irradiating light to plural kinds of optical information recording media with high reliability and of converging light reflected from the media, and to an optical pickup device employing the plastic optical element.

### TECHNICAL BACKGROUND

An optical pickup device is installed in information apparatus such as a player, a recorder and a drive for reading out information from an optical information recording medium (hereinafter referred to as simply a medium) such as an MO, CD and DVD or for or recording on the medium. The optical pickup device has an optical element unit for irradiating light having a prescribed wavelength generated from a light source to the medium and for receiving the reflected light by a light receiving element, and the optical element unit comprises an optical element such as a lens for condensing the light on the reflective surface of the medium or the light receiving element.

A plastic is preferably applied for the material of the optical element of the optical pickup device because the optical element can be manufactured at low cost through a means such as an injection molding. A copolymer of cyclic olefin and α-olefin is known as a plastic capable of applying the optical element (see for example, Patent Document 1).

In an information apparatus capable of reading or writing information to plural kinds of recording media such as a CD/DVD player, it is necessary that the optical pickup device has a constitution capable of responding to light having a different wavelength to be applied to each of the media and to the shape thereof. In such the case, the optical element unit is preferably one commonly applicable to both of the media from the viewpoint of cost and pickup property.

In recent years, a medium such as a blue-ray Disc recording and reproducing information employing light with a wavelength shorter than CD (λ=780 nm) or DVD (λ=635, 650 nm) or an information device capable of reading and writing information employing the medium has been developed as a medium capable of recording information in a density higher than CD or DVD.

When a plastic material is applied as material for an optical element, volume shrinkage or expansion occurs depending on circumstances under which the optical element is used, due to temperature elevation or humidity absorption, and cracks occur in an anti-reflection film provided on the plastic material. In order to overcome that problem, an attempt has been proposed in which an anti-moisture film of an inorganic film is provided on the entire surface of the plastic material (see for example, Patent document 2 and 3). This method is effective for a specific material, however, it is specific and insufficient in adhesion for a material containing cyclicolefin usually used in an optical pickup device, and does not prevent cracks from occurring.

In the so-called next generation DVD such as a Blue-ray Disc, a 400 nm light is used for recording or reproducing information. When even an optical element obtained from a combination of techniques disclosed in Patent documents 1, 2 and 3 is exposed to such a light with such a short wavelength, deterioration such as generation of white turbidity or variation of refractive index occurs. This shortens lifetime of the optical element, and requires exchange of the optical element.

Patent document 1: Japanese Patent O.P.I. Publication No. 2002-105231 (page 4)
Patent document 2: Japanese Patent O.P.I. Publication No. 2005-173326
Patent document 3: Japanese Patent O.P.I Publication No. 2004-361732

### DISCLOSURE OF THE INVENTION

### Problems to be Solved by the Invention

Accordingly, an object of the invention is to manufacture a plastic optical element with excellent durability and to provide an optical pickup device with excellent pickup property.

### Means for Solving the Above Problems

The present inventors have made an extensive study, and as a result, it has proved that stability of a gas barrier film increasing a moisture vapor or gas shielding property depends on adhesion of a ceramic layer (film) as a gas barrier film to a substrate, and deterioration of initial barrier property due to durability test such as repeated thermo tests under high temperature and high humidity is due to the fact that increase in film density for increasing gas barrier function produces compression stress inside the film. It has been found that improvement in barrier property can be attained by adjusting stress of a layer to generate a slight compression stress and by increasing density of the layer. The above problem of the invention can be solved by the following constitutions.

(1) A plastic optical element with a gas barrier film comprising a resin substrate and provided thereon, at least one ceramic layer, the residual stress of the ceramic layer being from 0.01 to 100 MPa in terms of compression stress, and a density ratio Y (=ρf/ρb) satisfying the following inequality:

1≧Y>0.95

wherein ρf represents a density of the ceramic layer, and ρb represents a density of a layer which has the same composition ratio as the ceramic layer and which has been formed by thermal oxidation or thermal nitridation of a metal which is a base material of the ceramic layer.

(2) The plastic optical element with a gas barrier film of item 1 above, wherein the density ratio Y (=ρf/ρb) satisfies the following inequality:

1≧Y>0.98

(3) The plastic optical element with a gas barrier film of item 1 or 2 above, wherein the residual stress of the ceramic layer is from 0.01 to 10 MPa.

(4) The plastic optical element with a gas barrier film of any one of items 1 through 3 above, wherein a material constituting the ceramic layer is silicon oxide, silicon oxide nitride, silicon nitride, aluminium oxide or a mixture thereof.

(5) The plastic optical element with a gas barrier film of any one of items 1 through 4 above, wherein a ceramic layer having a density lower than the ceramic layer is provided between the substrate and the ceramic layer.

(6) The plastic optical element with a gas barrier film of any one of items 1 through 5 above, wherein the plastic optical element with a gas barrier film is a lens.

(7) An optical pickup device employing the plastic optical element with a gas barrier film of any one of items 1 through 6 above.

(8) A process of manufacturing a plastic optical element with a gas barrier film comprising a resin substrate and provided thereon, at least one ceramic layer, the process comprising the steps of exciting gas containing a thin layer-forming gas under atmospheric pressure or approximately atmospheric pressure by a high frequency electric field to obtain an excited gas, and exposing a resin substrate to the excited gas to form at least one ceramic layer on the resin substrate, wherein the residual stress of the ceramic layer is from 0.01 to 100 MPa in terms of compression stress, and a density ratio Y (=ρf/ρb) satisfies the following inequality:

1≧Y>0.95

wherein ρf represents a density of the ceramic layer, and ρb represents a density of a layer which has the same composition ratio as the ceramic layer and which has been formed by thermal oxidation or thermal nitridation of a metal which is a base material of the ceramic layer.

(9) The process of manufacturing a plastic optical element with a gas barrier film of item 8 above, wherein the gas contains a nitrogen gas in an amount of not less than 50% by volume.

(10) The process of manufacturing a plastic optical element with a gas barrier film of item 8 or 9 above, wherein the high frequency electric field is one in which a first high frequency electric field and a second high frequency electric field are superposed, frequency ω2 of the second high frequency electric field is higher than frequency ω1 of the first high frequency electric field, and the following inequality is satisfied:

V1≧IV>V2 or V1>IV≧V2

wherein V1 represents intensity of the first high frequency electric field, V2 represents intensity of the second high frequency electric field, and IV represents intensity at the time discharge begins.

(11) The process of manufacturing a plastic optical element with a gas barrier film of item 10 above, wherein the output density of the second high frequency electric field is not less than 1 W/cm².

(12) The process of manufacturing a plastic optical element with a gas barrier film of any one of items 8 through 11 above, wherein the resin substrate is maintained by a dielectric.

### Effects of the Invention

The present invention provides a plastic optical element with a gas barrier film comprising a ceramic layer with excellent adhesion to a substrate, less cracks, high density and high durability, a manufacturing method of a plastic optical element with a gas barrier film providing high durability, and an optical pickup device with excellent pickup property employing the plastic optical element.

### BRIEF DESCRIPTION OF THE DRAWINGS

FIG. 1 is a diagram showing the relationship between degree of vacuum and the residual stress of a silicon oxide layer formed by a vacuum vapor deposition method.

FIG. 2 is a schematic diagram showing the layer structure of the plastic optical element with a gas barrier film of the present invention.

FIG. 3 is a schematic view showing an example of the jet type atmospheric pressure plasma discharge processing apparatus useful in the present invention.

FIG. 4 is a schematic view showing an example of the atmospheric pressure plasma discharge processing apparatus for processing a substrate between opposing electrodes, which is useful in the present invention.

FIG. 5 is a perspective view showing an example of the structure of a prismatic electrode in which a conductive metallic base material covered with a dielectric.

### DESCRIPTION OF REFERENCE NUMERALS

1, 2. Plastic optical element with gas barrier film
3. Ceramic layer
4. Polymer-containing layer
Y. Resin substrate
10, 510. Plasma discharge processing apparatus
11. First electrode
12. Second electrode
14. Processing position
21, 502. First power source
22, 521. Second power source
36D. Dielectric
508. Stage electrode (first electrode)
511, 512. Fixed prismatic electrode group (second electrode)
36a. Prismatic electrode
36A. Metallic base material
F. Substrate

### PREFERRED EMBODIMENT FOR CARRYING OUT THE INVENTION

Next, preferred embodiment of the invention will be explained, but the invention is not limited thereto.

The plastic optical element with a gas barrier film of the invention is an optical element comprising a resin substrate and provided thereon, at least one ceramic layer, wherein the density ratio Y (=ρf/ρb) satisfies the following inequality:

1≧Y>0.95

wherein ρf represents a density of the ceramic layer, and ρh represents a density of a layer which has the same composition ratio as the ceramic layer and which has been formed by thermal oxidation or thermal nitridation of a base material constituting the ceramic layer.

The residual (internal) stress of the ceramic layer is preferably from 0.01 to 100 MPa in terms of compression stress. This plastic optical element provides high durability and excellent gas barrier function, having a vapor permeability of 0.1 g/m²/day or less, preferably 0.01 g/m²/day or less, and an oxygen permeability of 0.1 ml/m²/day or less, preferably 0.01 ml/m²/day, as measured according to JIS K7129B.

Components constituting the plastic optical element with a gas barrier film will be explained below.

The gas barrier film (layer) in the present invention will be explained. There is no restriction on the composition of the gas barrier film in the present invention so long as it is a film that blocks passage of oxygen and vapor. A material constituting the gas barrier film in the present invention is preferably an inorganic oxide, and examples of the inorganic oxide include silicon oxide, aluminum oxide, silicon oxynitride, aluminum oxynitride, magnesium oxide, zinc oxide, indium oxide and tin oxide.

The optimum thickness of the gas barrier film in the present invention differs according to the kind and structure of materials to be used, and is selected accordingly. The thickness is preferably from 5 to 2000 nm. When the thickness of the gas barrier film is below the above range, a uniform film cannot be obtained, and satisfactory gas barrier function cannot be ensured. When the thickness of the gas barrier film is above the above range, the shape of the plastic optical element varies, resulting in variation of its optical property.

In the present invention, the ceramic layer as a gas barrier film formed on the resin substrate should be formed in such a way that a density ratio Y (=ρf/ρb) satisfies the following inequality:

1≧Y>0.95

wherein ρf represents a density of the ceramic layer, and ρb represents a density of a layer which has the same composition ratio as the ceramic layer and which has been formed by thermal oxidation or thermal nitridation of the base material.

The density ratio Y (=ρf/ρb) preferably satisfies the following inequality:

1≧Y>0.98.

In the present invention, the density of the ceramic layer formed on the resin substrate can be obtained by a conventional analysis method. In the present invention, a value obtained by an X-ray reflectivity method is used.

For the outline of the X-ray reflectivity method, reference should be made to “X-ray Diffraction Handbook”, P.151 (edited by Rigaku Denki Co., Ltd., 2000, International Document Publishing Co., Ltd.) or “Chemical Industries”, No. 22 Jan. 1999.

Embodiment of the measurement method used in the present invention will be explained below.

The X-ray reflectivity method is a method in which measurement is carried out applying X-rays to a substance having a flat surface at a very small angle, wherein a measuring instrument MXP21 manufactured by MacScience Inc. is used. Copper is employed as a target of the X-ray source, and operation is performed at a voltage of 42 kV and at an amperage of 500 mA. A multi-layer film parabolic mirror is used as an incident monochrometer. A 0.05 mm×5 mm incident slit and a 0.03 mm×20 mm light receiving slit are employed. According to the 2θ/θ scanning technique, measurement is carried out at a step width of 0.005° in the range from 0 to 5°, 10 seconds for each step by the FT method. Curve fitting is applied to the resulting reflectivity curve, using the Reflectivity Analysis Program Ver. 1 of MacScience Inc. Each parameter is obtained so that the residual sum of squares between the actually measured value and fitting curve will be minimized. From each parameter, the thickness and density of the lamination layer can be obtained. The thickness of the lamination layer in the present invention can also be obtained according to the aforementioned X-ray reflectivity method.

This method can be used to measure the density (ρf) of for example, a ceramic layer made of silicon oxide, silicon nitride, silicon oxynitride, etc., which is formed by an atmospheric pressure plasma method described later or a vapor deposition method.

The ceramic layer is required to be dense and is preferably within the aforementioned range in terms of the density ratio Y (=ρf/ρb) which is the ratio of density of the ceramic layer to density (ρb) of the bulk ceramic having the same composition as the ceramic layer, (density of silicon oxide of the bulk when the ceramic layer to be formed is a silicon oxide layer). The ceramic layer having a density closer to that of the bulk is more dense and preferred. A method to prepare the aforementioned film stably is preferable.

As the density of the above bulk layer is used a density of a ceramic layer formed by thermal oxidation or thermal nitridation of a base metal material of a ceramic layer, which is a gas barrier film formed on a resin substrate according to a vapor deposition method or a plasma CVD method. When a ceramic layer is formed from silicon oxide, the silicon substrate corresponds to a base metal material.

Formation of the silicon oxide layer by thermal oxidation of silicon substrate is widely known. A thermal oxidation layer is formed on the surface of a silicon substrate by exposing the silicon substrate to an oxygen atmosphere, for example, at 1100° for about one hour. The property of the silicon oxide layer has been much studied in the field of semiconductors. In the silicon oxide layer, an approximately 1 nm-thick transition layer having a structure different from that of the bulk silicon oxide is known to be present close to the boundary of the silicon substrate. Thus, a silicon oxide layer of a sufficient thickness (100 nm or more) is formed in order to avoid adverse effect of this portion. Further, formation of a thermal nitridation layer is also known. A thermal nitridation layer is formed on the surface of a silicon substrate by exposing the silicon substrate to an ammonia atmosphere, for example, at 1100° for about one hour.

The aforementioned statement also applies to the oxynitridation layer and nitridation layer. A ceramic layer having the same composition is formed by thermal oxynitridation or nitridation of the base material, for example, a metal substrate by adjusting conditions such as the type and flow rate of gas, temperature and time, and the density thereof is measured as density (ρb) of the bulk according to the aforementioned X-ray reflectivity method.

The residual stress of the ceramic layer formed on the resin substrate is preferably from 0.01 to 100 MPa in terms of compression stress.

For example, when the resin film having a ceramic layer formed by a vapor deposition method, a CVD method or a sol-gel method is allowed to stand under predetermined conditions, a positive curl or a negative curl occurs due to difference in film property between the substrate film and the ceramic layer. This curl is produced by stress occurring in the ceramic layer. The greater the degree of curl (positive), the greater the compressive stress is.

The following method is utilized to measure the internal stress of the ceramic layer. A ceramic layer having the same composition and thickness as those of a film to be measured is formed on a quartz substrate having a width of 10 mm, a length of 50 mm and thickness of 0.1 mm according to the same procedure. Curl occurring in the sample having been produced is measured employing a thin layer evaluation device, Model MH4000 manufactured by NEC SANEI Co., Ltd., with the concave portion of the sample facing upward. Generally, positive curl in which the film side is contracted against the substrate by compression stress is expressed by positive stress. In contrast, when negative curl generated by tensile stress is expressed by negative stress.

In the present invention, the stress value is preferably 200 MPa or less, more preferably from 0.01 to 100 MPa and still more preferably from 0.01 to 20 MPa in the positive range.

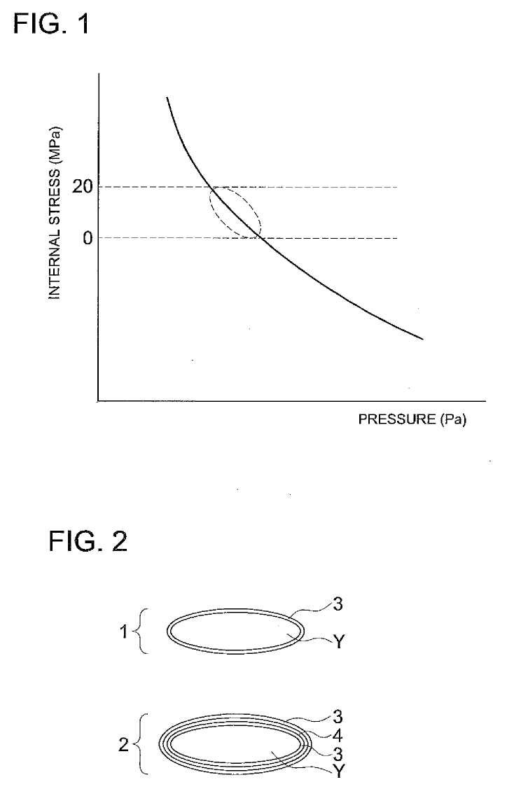

The residual stress of the resin substrate with a silicon oxide layer formed thereon can be regulated by adjusting a vacuum degree, for example, when the silicon oxide layer is formed by a vapor deposition method. FIG. 1 shows the relationship between a vacuum degree in a chamber where a 1 μm-thick silicon oxide layer is formed on a quartz substrate having a width of 10 mm, a length of 50 mm and a thickness of 0.1 mm according to a vacuum deposition method, and the residual (internal) stress of the formed silicon oxide layer measured by the foregoing method. In FIG. 1, a ceramic layer having a residual stress of from more than 0 MPa to approximately 100 MPa is preferable, but fine adjustment, particularly fine control is difficult, and therefore, the above range cannot be secured in most cases. If the stress is too small, partial tensile stress sometimes occurs, the layer is less durable and is subjected to cracks and fracture. If the stress is excessive, the layer tends to be broken.

In the present invention, there is no particular restriction to a method of manufacturing a ceramic layer as a gas barrier film. For example, the ceramic layer can be formed by a wet processing method such as a sol-gel method. However, a wet processing method such as a spray coating method or a spin coating method is difficult to obtain smoothness at the molecular level (on the order of “nm”). Further, such a wet processing method has problem in that since a solvent is used and a substrate described later is made of an organic material, there is restriction on the type of the substrate or solvent to be used. Thus, in the present invention, the ceramic layer is preferably formed by a sputtering method, an ion assist method, a plasma CVD method described later or an atmospheric pressure or approximately atmospheric pressure plasma CVD method described later. Especially the atmospheric pressure plasma CVD method is a high-speed film making method with high productivity, eliminating a pressure-reduced chamber. A gas barrier film formed by the plasma CVD method has a uniform and smooth surface, and a layer with very small internal stress (of from 0.01 to 100 MPa) can be produced with comparative ease by the plasma CVD method.

To improve the density ratio in the atmospheric pressure plasma method, it is preferred to increase the output of a high-frequency power. Especially, a film-forming speed in a discharge space is preferably not more than 10 mm/sec., and the output density is preferably 10 W/cm² or more, and more preferably 15 W/cm² or more.

To perform function as the gas barrier film, the thickness of the ceramic layer is preferably from 5 to 2000 nm, as described previously.

If the thickness is lower than that range, layer defects will occur and a sufficient moisture resistance cannot be ensured. Theoretically, a greater thickness provides a greater moisture resistance, but when the thickness is excessively high, the shape of a plastic optical element varies, resulting in variation of its optical property.

In the present invention, the ceramic layer as a gas barrier layer is preferably transparent. The light transmittance of the gas barrier film is preferably 80% or more, and more preferably 90% or more, when the wavelength of the test light is 550 nm.

The plasma CVD method or the atmospheric pressure or approximately atmospheric pressure plasma CVD method is preferred, since it can form a ceramic layer of a metal carbide, a metal nitride, a metal oxide, a metal sulfide or a mixture thereof (metal oxynitride or metal carbide nitride) by selecting conditions such as the type of an organometallic compound as raw material (also called material), a decomposition gas, a decomposition temperature and an input power.

For example, if the silicon compound is used as a material compound and oxygen is used as a decomposition gas, a silicon oxide can be produced. When a zinc compound is used as a material and carbon disulfide is used as a decomposition gas, zinc sulfide is produced. This is because multi-step chemical reactions are promoted at a very high speed in a plasma space due to high-density presence of activated charged particles and active radicals in the plasma space, and elements present in the plasma space are converted into a thermodynamically stable compound in a very short period of time.

An inorganic material can be in any state of gas, liquid or solid at the normal temperature and at normal pressure if it contains a typical or transitional metal element. A gaseous material can be introduced into a discharge space directly, but a liquid or solid material is gasified by heating, bubbling, depressurization or ultrasonic irradiation. Alternatively, it can be used after being diluted by solvent. Examples of the solvent include an organic solvent such as methanol, ethanol, n-hexane or the mixture thereof. The solvent for dilution is decomposed into molecules and atoms during plasma discharge processing, and its influence can be almost ignored.

Examples of a silicon compound as the organometallic compound include silane, tetramethoxy silane, tetraethoxy silane (TEOS), tetra-n-proxy silane, tetraisoproxy silane, tetra-n-butoxy silane, tetra-t buthoxy silane, dimethyl dimethoxy silane, dimethyl diethoxy silaue, diethyl dimethoxy silane, diphenyl di-methoxy silane, methyl triethoxy silane, ethyl triethoxy silane, phenyl triethoxy silane, (3,3,3-trifluoropropyl) triethoxy silane, hexamethyl disiloxane, bis(dimethylamino)dimethyl silane, bis((dimethyl amino)methyl vinyl silane, bis(ethylamino)dimethyl silane, N,O-bis(trimethyl silyl) acetoamide, bis(trimethyl silyl) carbodiimide, diethylamino trimethyl silane, dimethylaminodimethyl silane, hexamethyl disilazane, hexamethyl cyclo trisilazane, heptamethyl disilazane, nonamethyl trisilazane, octamethylcyclo tetrasilazane, tetrakis dimethylamino silane, tetraisocyanate silane, tetramethyl disilane, tris(dimethylamino) silane, triethoxy fluorosilane, allyldimethyl silane, allyltrimethyl silane, benzyltrimethyl silane, bis(trimethylsilyl)acetylene, 1,4-bistrimethylsilyl-1,3-butadiene, di-t-butyl silane, 1,3-disilabutane, bis(trimethylsilyl)methane, cyclopentadienyl trimethyl silane, phenyl dimethylsilane, phenyl trimethylsilane, propargyl trimethylsilane, tetramethyl silane, trimethylsilyl acetylene, 1-(trimethyl silyl)-1-propyne, tris(trimethylsilyl)methane, tris(trimethylsilyl) silane, vinyl trimethylsilane, hexamethyl disilane, octamethyl cyclotetrasiloxane, tetramethyl cyclotetrasiloxane, hexamethyl cyclotetrasiloxane and M silicate 51.

Examples of a titanium compound include titanium tetraethoxide, Litanium tetraethoxide, titanium tetraisopropoxide, titanium tetra-n-butoxide, titanium diisopropoxide bis-2,4-pentane dionate), titanium diisopropoxide (bis-2,4-ethylaceto acetate), titanium di-n-butoxide(bis-2,4-pentanedionate), titanium acetylacetonate, and butyl titanate dimer.

Examples of a zirconium compound include zirconium n-propoxide, zirconium n-butoxide, zirconium t-butoxide, zirconium tri-n-butoxide acetylacetonate, zirconium di-n-butoxide bisacetylacetonate, zirconium acetylacetonate, zirconium acetate, and zirconium hexafluoropentanedionate.

Examples of an aluminum compound include aluminum ethoxide, aluminum triisopropoxide, aluminum isopropoxide, aluminum n-butoxide, aluminum s-butoxide, aluminum t-butoxide, aluminum acetylacetonate, and triethyl dialuminum tri-s-butoxide.

Examples of a boron compound include diborane, tetraborane, boron fluoride, boron chloride, boron bromide, boron diethyl ether complex, boron-THF complex, boron-dimethyl sulfoide complex, boron diethyl ether trifluoride complex, triethyl boron, trimethoxy boron, triethoxy boron, tri(isopropoxy)boron, borazole, trimethyl borazole, triethyl borazole, and triisopropyl borazole.

Examples of a tin compound include tetraethyl tin, tetramethyl tin, di-n-butyl tin diacetate, tetrabutyl tin, tetraoctyl tin, tetraethoxy tin, methyltriethoxy tin, diethyl diethoxy tin, triisopropyl ethoxy tin, diethyl tin, dimethyl tin, diisopropyl tin, dibutyl tin, diethoxy tin, dimethoxy tin, diisopropoxy tin, dibutoxy tin, tin dibutylate, tin diacetoacetonate, ethyl tin acetoacetonate, ethoxy tin acetoacetonate, dimethyl tin acetoacetonate, a tin hydrogen compound, and a halogenated tin such as tin dichloride or tin tetrachloride.

Examples of other organometallic compound include antimony ethoxide, arsenic triethoxide, barium 2,2,6,6-tetramethyl heptanedionate, beryllium acetylacetonate, bismuth hexafluoro pentane dionate, dimethyl cadmium, calcium 2,2,6,6-tetramethyl heptanedionate, chromium trifluoro pentanedionate, cobalt acetylacetonate, copper hexafluoro pentanedionate, magnesium hexafluoro pentanedionate-dimethyl ether complex, gallium ethoxide, tetraethoxy germane, tetramethoxy germane, hafnium t-butoxide, hafnium ethoxide, indium acetyl acetonate, indium 2,6-dimethyl aminoheptanedionate, ferrocene, lanthanum isopropoxide, lead acetate, lead tetraethyl, neodymium acetyl acetonate, platinum hexafluoro pentanedionate, trimethyl cyclopentadienyl platinum, rhodium dicarbonyl acetyl acetonate, strontium 2,2,6,6-tetramethyl heptanedionate, tantalum methoxide, tantalumtrifluoro ethoxide, tellurium ethoxide, tungsten ethoxide, vanadium triisopropoxide oxide, magnesium hexafluoro acetyl acetonate, zinc acetyl acetonate, and diethyl zinc.

Examples of a decomposition gas for obtaining an inorganic compound by decomposing the metal-containing material gas include a hydrogen gas, a methane gas, an acetylene gas, a carbon monoxide, a carbon dioxide, a nitrogen gas, an ammonium gas, a nitrous oxide gas, a nitrogen oxide gas, a nitrogen dioxide gas, an oxygen gas, vapor, a fluorine gas, hydrogen fluoride, trifluoroalcohol, trifluorotoluene, hydrogen sulfide, sulfur dioxide, carbon disulfide, and a chlorine gas.

Various types of metal carbides, metal nitrides, metal oxides, metal halides and metal sulfides can be obtained by proper selection of the metal element-containing material gas and the decomposition gas.

These reactive gases are mixed with a discharge gas easily converted into a plasma state, and fed into a plasma discharge generation apparatus.

Examples of such a discharge gas include a nitrogen gas and/or Group XVIII element of the Periodic Table exemplified by helium, neon, argon, krypton, xenon and radon. Of these elements, nitrogen, helium, and argon are preferred and nitrogen is more preferred in view of low cost.

The discharge gas and reactive gas as described above are mixed to form a mixed gas, which is supplied to a plasma discharge generation apparatus (plasma generation apparatus) to form a layer. The mixing ratio of the discharge gas and reactive gas depends on the properties of the layer to be formed, but a reactive gas is supplied so that the percentage of the discharge gas based on mixed gas is 50% by volume or more.

In the ceramic layer used as a gas barrier film in the present invention, the inorganic compound contained in the ceramic layer is preferably SiOₓC_{y} (x=1.5 to 2.0, y=0 to 0.5), SiOₓ, SiN_{y} or SiOₓN_{y} (x=1 to 2, y=0.1 to 1). SiOₓ is especially preferred from the viewpoint of gas barrier property, moisture permeability, light transmittance, or suitability to atmospheric pressure plasma CVD. That the ceramic layer giving ρb formed by thermal oxidation or thermal nitridation to be used for reference has “the same composition” as the ceramic layer in the present invention means that both ceramic layers have the same atomic composition.

In the ceramic layer in the present invention containing the inorganic compound, for example, a layer containing a silicon atom and at least one of an oxygen atom and a nitrogen atom can be obtained by mixing the aforementioned organic silicon compound with an oxygen gas, a nitrogen gas or an ammonia gas with at a predetermined ratio.

As described above, various kinds of inorganic thin layers can be formed on a substrate, using the aforementioned material gas together with the discharge gas.

The resin substrate used in the plastic optical element of the invention will be explained below.

Though transparent thermoplastic resin materials usually employed for optical material can be employed as the organic resin material (host material) in the invention without any limitation, an acryl resin, a cyclic olefin resin, a polycarbonate resin, a polyester resin, a polyether resin, a polyamide resin and a polyimide resin are preferable considering the processing suitability of the resin as the optical element. The compounds disclosed in Japanese Patent O.P.I. Publication Nos. 2003-73559 can be exemplified. Preferable examples thereof will be listed in Table 1.

| | | | Abbe |
|---|---|---|---|
| Resin | | Refractive | constant |
| No. | Structure | index n | ν |
| (1) | 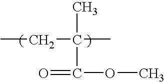 | 1.49 | 58 |
| (2) | 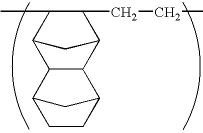 | 1.54 | 56 |
| (3) | 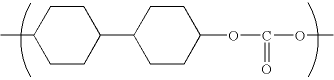 | 1.53 | 57 |
| (4) | 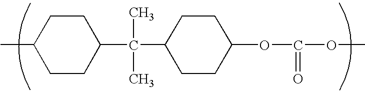 | 1.51 | 58 |
| (5) | 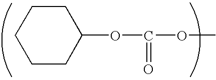 | 1.52 | 57 |
| (6) | 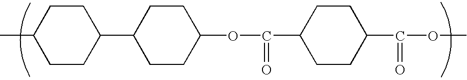 | 1.54 | 55 |
| (7) | 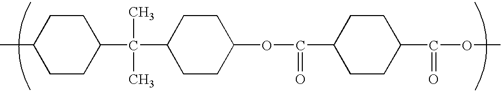 | 1.53 | 57 |
| (8) | 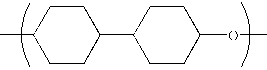 | 1.55 | 57 |
| (9) | 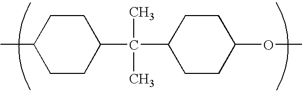 | 1.54 | 57 |
| (10) | 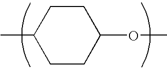 | 1.55 | 58 |
| (11) | 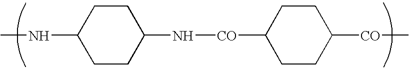 | 1.55 | 53 |
| (12) | 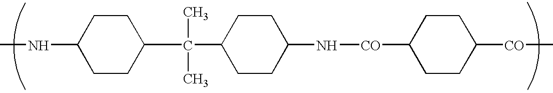 | 1.54 | 55 |
| (13) | 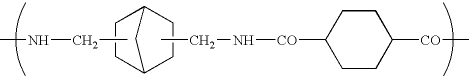 | 1.54 | 56 |
| (14) | 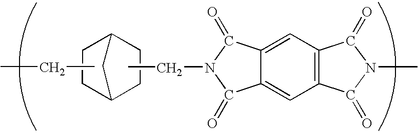 | 1.58 | 43 |

The host materials as the organic polymer in the resin material in the invention are preferably compounds disclosed in Japanese Patent O.P.I. Publication No. 7-145213, paragraphs [0032] to [0054], which are olefin polymers having a cyclic structure obtained by hydrogenation of an copolymer of an α-olefin having 2 to 20 carbon atoms and a cyclic olefin, or alicyclic hydrocarbon copolymers comprising a repeating unit having a cyclic structure. Examples of the cyclic olefin resin preferably used in the invention include ZEONEX (Nihon Zeon Co., Ltd.), APEL (Mitsui Kagaku Co., Ltd.), ARTON (JSR Co., Ltd.) and TOPAS (Chikona Co., Ltd.), but the resin is not limited thereto.

### <<Other Additives>>

Various kinds of additives (ingredients) can be added according to necessity during preparation process of the resin material or formation process of the resin composition in the present invention. Examples of the additive include a stabilizing agent such as an antioxidant, a thermal stabilizer, a light proofing stabilizer, a weather proofing stabilizer, a UV absorbent and a near-infrared absorbent; a resin improving agent such as a slipping agent and a plasticizer; a turbid preventing agent such as a soft polymer and an alcoholic compound; a colorant such as a dye and a pigment; and a anti-static agent, a flame retardant and a filler, though the additive is not specifically limited. These additives may be employed singly or in combination. The adding amount of the additive is suitably determined within the range in which the effects of the present invention are not jeopardized. In the present invention, it is preferred that the polymer contains at least a plasticizer or an antioxidant.

### <Plasticizer>

Though the plasticizer is not specifically limited, a phosphate plasticizer, a phthalate plasticizer, a trimellitate plasticizer, a pyromellitate plasticizer, a glycolate plasticizer, a citrate plasticizer and a polyester plasticizer can be exemplified.

Examples of the phosphate plasticizer include triphenyl phosphate, tricresyl phosphate, cresyl phenyl phosphate, octyl diphenyl phosphate, diphenyl biphenyl phosphate, trioctyl phosphate and tributyl phosphate; those of the phthalate plasticizer include diethyl phthalate, dimethoxyethyl phthalate, dimethyl phthalate, dioctyl phthalate, dibutyl phthalate, di-2-ethylhexyl phthalate, butyl benzyl phthalate, diphenyl phthalate and dicyclohexyl phthalate; those of the trimellitate plasticizer include tributyl trimellitate, triphenyl trimellitate and triethyl trimellitate; those of pyromellitate include tetrabutyl pyromellitate, tetraphenyl pyromellitate and tetraethyl pyromellitate; those of glycolate plasticizer include triacetine, tributyline, ethyl phthalyl ethyl glycolate, methyl phthalyl ethyl glycolate and butyl phthalyl butyl glycolate; and those of the citrate plasticizer include triethyl citrate, tri-n-butyl citrate, acetyltriethyl citrate, acetyltri-n-butyl citrate and acetyltri-n-(2-ethylhexyl) citrate.

### <Antioxidant>

As the antioxidant, a phenol antioxidant, a phosphorus antioxidant and a sulfur antioxidant are usable and the phenol antioxidant, particularly an alkyl-substituted phenol antioxidant, is preferable. BY the addition of such the antioxidants, coloring and strength lowering of the lens caused oxidation on the occasion of the lens formation can be prevented without lowering in the transparency and the resistivity against heat. These antioxidants may be employed singly or as an admixture of two or more kinds thereof. Though the adding amount of the antioxidant may be optionally determined within the range in which the effects of the present invention are not jeopardized, the amount is preferably from 0.001 to 5 parts by weight, and more preferably from 0.01 to 1 part by weight based on 100 parts by weight of the polymer in the present invention.

Known phenol antioxidants can be employed. Examples of the phenol antioxidant include acrylate compounds described in Japanese Patent O.P.I. Publication Nos. 63-179953 and 1-168643 such as 2-t butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenyl acrylate; alkyl-substituted phenol compounds such as octadecyl-3-(3,5-di-t-butyl-4-hydroxyphenyl propionate, 2,2′-methylene-bis(4-methyl-6-t-butylphenyl) 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenyl propionate)methane namely pentaerythrimethyl-tetrakis(3-(3,5-di-t-butyl-4-hydroxyphenyl propionate)) and triethylene glycol-bis(3-(3-t-butyl-4-hydroxy-5-methylphenyl)propionate; and triazine group-containing phenol compounds such as 6-(4-hydroxy-3,5-di-t-butylanilino)-2,4-bisoctylthio-1,3,5-triazine, 4-bisoctylthio-1,3,5-triazine and 2-octylthio-4,6-bis(3,5-di-t-butyl-4-oxyanilino)-1,3,5-triazine.

The phosphor antioxidants usually employed in the resin industry are usable without any limitation. Examples of the phosphor antioxidant include monophosphites such as triphenyl phosphite, diphenyl isodecyl phosphite, phenyl diisodecyl phosphite, tris(nonylphenyl) phosphite, tris(dinonylphenyl) phosphite, tris(2,4-di-t-butylphenyl) phosphite and 10-(3,5-di-t-butyl-4-hydroxybenzyl)-9,10-dihydro-9-oxa-10-phosphaphenathlene-10-oxide; and diphosphites such as 4,4′-butylidene-bis(3-methyl-6-t-butylphenyl-di-tridecyl phosphite) and 4,4′-isopropylidene-bis(phenyl-di-alkyl (C12-C15) phosphite. Among them, the monophosphites are preferred, and tris(nonylphenyl) phosphite, tris(dinonyl-phenyl)phosphite and tris(2,4-di-t-butylphenyl) phosphite are especially preferred.

Examples of the sulfur antioxidant include dilauryl 3,3-thiodipropionate, dimiristyl 3,3-thiodipropionate, distearyl 3,3-thiodipropionate, lauryl stearyl 3,3-thiodipropionate, penterythritol-tetrakis(β-lauryl-thio-propionate) and 3,9-bis(dodecylthioethyl)-2,4,8,10-tetraoxaspiro[5,5]undecane.

### <Light Stabilizer>

As a light stabilizer, a benzophenone light stabilizer, a benzotriazole light stabilizer and a hindered amine light stabilizer are cited. In the present invention, the hindered amine light stabilizers are preferably employed from the viewpoint of transparency and anti-coloring property of a lens. Among the hindered amine light stabilizer (hereinafter also referred to as HALS), ones having an Mn in terms of polystyrene measured by GPC using tetrahydrofuran (THF) of preferably from 1,000 to 10,000, more preferably from 2,000 to 5,000, and still more preferably from 2,800 to 3,800 are preferred. HALS having too small Mn is difficulty added to the block-copolymer by the reason of its evaporation when the HALS is added thereto while heating, meting and kneading, or the processing suitability is lowered since a bubble and a silver streak are produced while heating, melting or molding. Furthermore, when a plastic optical element such as a lens is used for long time while a lamp is on, the volatile ingredient is generated in a gas state from the lens. HALS having too large Mn is low in the dispersibility in the block copolymer, so that the transparency of the lens is decreased and the improving effect on the light stabilization is lowered. In the present invention, therefore, the HALS having the Mn falling within the above range provides a plastic optical element having excellent processing stability, low gas formation and high transparency.

Typical examples of the HALS include a high molecular weight HALS composed by combining plural piperidine rings through triazine skeletons such as a polycondensation product of N,N′,N″,N′″-tetrakis-[4,6-bis-{butyl-(N-methyl-2,2,6,6-tetramethylpiperidine-4-yl)amino}-triazine-2-yl]-4,7-diazadecane-1,10-diamine, dibutylamine 1,3,5-triazine and N,N′-bis(2,2,6,6-tetramethyl-4-piperidyl)butylamine, a polycondensation product of poly[{(1,1,3,3-tetramethylbutyl)amino-1,3,5-triazine-2,4-di-yl}{(2,2,6,6-tetramethyl-4-piperidyl)imino}hexamethylene{(2,2,6,6-tetramethyl-4-piperidyl)imino}], 1,6-hexanediamine-N,N″-bis(2,2,6,6-tetramethyl-4-piperidyl) and morpholine-2,4,6-trichloro-1,3,5-triazine, and poly[(6-morpholino-s-triazine-2,4-di-yl)(2,2,6,6-tetramethyl-4-piperidyl)imino]-hexamethylene-[(2,2,6,6-tetramethyl-4-piperidyl)imino]; and a high molecular weight composed by combining piperidine rings through ester bonds such as a polymer of dimethyl succinate and 4-hydroxy(2,2,6,6-tetramethyl-1-piperidinemethanol, and a mixed ester of 1,2,3,4-butanetetracarboxylic acid, 1,2,2,6,6-pentamethyl-4-piperidinol and 3,9-bis(2-hydroxy-1,1-dimethylethyl)-2,4,8,10-tetraoxaspiro[5,5]undecane.

Among them, ones having an Mn of from 2,000 to 5,000 such as a polycondensation product of dibutylamine 1,3,5-triazine with N,N′-bis(2,2,6,6-tetramethyl-4-piperidyl)butylamine, poly[{(1,1,3,3-tetrabutylmethyl)amino-1,3,5-triazine-2,4-diyl}{(2,2,6,6-tetramethyl-4-piperidyl)imino}-hexamethylene{(2,2,6,6-tetramethyl-4-piperidyl)imino}], and a polymeric compound of dimethyl succinate with 4-hydroxy-2,2,6,6-tetramethyl-1-piperidinemethanol are preferred.

The adding amount of the above-compounds to the resin material in the present invention is preferably from 0.01 to 20 parts by weight, more preferably from 0.02 to 15 parts by weight, and still more preferably from 0.05 to 10 parts by weight, based on 100 parts by weight of the resin material. When the adding amount is too small, the satisfactory improving effect in the light resistivity cannot be obtained, so that coloring is caused during use for log period at out of door. When the adding amount is excessively large, a part of it volatiles as gas or the dispersion property in the resin is lowered, which results in lowering of the transparency of for example) a lens as a plastic optical element.

Addition of a compound having the lowest glass transition point of not more than 30° C. to the resin material in the present invention can prevent occurrence of white turbid without lowering properties such as transparency, heat resistivity and mechanical strength even when the resin material is handled for long period under high temperature and high humid condition.

With respect to the method of manufacturing the plastic optical element with a gas barrier film of the present invention, a plasma CVD method and an atmospheric pressure plasma CVD method which are preferably employed to form a gas barrier film or a ceramic layer will be explained in detail below.

The plasma CVD method in the invention will be explained below.

The plasma CVD method (chemical gas phase growing method) is a method in which a volatilized and sublimed organometallic compound is deposited on the surface of a high-temperature substrate and thermally decomposed, whereby a thermally stable thin layer of an inorganic substance is formed. In this conventional CVD method (also called a thermal CVD method), the substrate temperature is required to be 500° C. or more. Thus, this method cannot be easily applied to formation of a layer on a plastic substrate.

On the other hand, in the plasma CVD method, electric field is applied to a space in the vicinity of a substrate, whereby a space (plasma space) in which gas in a plasma state exists is created. A volatilized and sublimed organometallic compound is introduced into this plasma space, decomposed and blown onto the substrate to form an inorganic thin layer thereon. In the plasma space, a high percentage of gas (as high as several percent) is ionized into ions and electrons. Although gas temperature is kept low, the organometallic compound as raw material for the inorganic layer can be decomposed at a low temperature wherein the substrate is brought into contact with electrons of high temperature or gas of low temperature but in excited state such as an ion radical. Thus, the plasma CVD method can lower temperature of a substrate on which an inorganic layer is formed and can form a thin layer on a resin substrate.

However, in the plasma CVD method, it is necessary that electric field is applied to gas whereby the gas is ionized to be in a plasma state, and a film is ordinarily formed in the space of reduced pressure ranging from 0.101 to 10.1 kPa. This requires an increased size of an equipment and a complicated operation procedure when manufacturing a large-area film. Thus, this method involves problem in productivity.

As compared with the vacuum plasma CVD method, the approximately atmospheric pressure plasma CVD method does not require reduced pressure, provides high productivity and high film making speed, since the plasma density is high. As compared with the normal conditions of the plasma CVD method, the mean free path of gas is very short under high-pressure condition such as atmospheric pressure, which forms an extremely flat film having excellent optical properties and excellent gas barrier function. For this reason, the atmospheric pressure plasma CVD method is preferred in the present invention as compared to the vacuum plasma CVD method.

When the aforementioned ceramic layer is formed on the resin substrate, this method forms a layer with high density and stable performances. This method also secures stable production of a ceramic layer having a residual stress of from 0.01 to 100 MPa in terms of compression stress.

FIG. 2 is a schematic diagram showing the layer structure of the plastic optical element with a gas barrier film of the invention. The plastic optical element 1 with a gas barrier film has a ceramic layer 3 on a resin substrate Y, e.g., cyclic polyolefin. The plastic optical element 2 with a gas barrier film comprises a resin substrate B, at least two ceramic layers 3 and a polymer layer 4 more flexible than the ceramic layer located between two ceramic films. The polymer layer is made of the resin used in the resin substrate of the plastic optical element with a gas barrier film. Examples of the resin include a polyolefin (PO) resin such as a homopolymer or copolymer of ethylene, polypropylene or butene; an amorphous polyolefin (APO) resin such as cyclic polyolefin; polyethylene terephthalate resin; and polycarbonate resin. The resin is not specifically limited, as long as it is an organic material capable of carrying the gas barrier film.

In the plastic optical element 2 with a gas barrier film, the ceramic films 3 and the polymer layers 4 are shown to be alternately laminated. There is no particular restriction to their order or number in the arrangement so long as the polymer layer is sandwiched between the inorganic layers.

The ceramic layer in the present invention has a dense structure and high hardness. The ceramic layer is preferably divided into a plurality of layers which are laminated through a stress relaxation layer. An adhesion layer can be provided to increase adhesion of the resin substrate. A protective layer can be provided to protect the surface. The stress relaxation layer reduces stress occurring in the ceramic layer and prevents cracks and other defects from occurring in the inorganic ceramic film. A ceramic layer having a low density and excellent adhesion to the resin substrate or a less hard and flexible ceramic layer resistant to cracks and damage as a stress relaxation layer can be obtained by selecting ceramic layer forming conditions (such as reaction gas, electric power and high-frequency power source), for example by changing a carbon content rate.

An adhesion layer to enhance adhesion to a resin substrate instead of the polymer layer, a stress relaxation layer or a protective layer can be made of the same ceramic materials.

Next, a method of manufacturing the gas barrier film will be explained which employs an atmospheric pressure or approximately atmospheric pressure plasma CVD method.

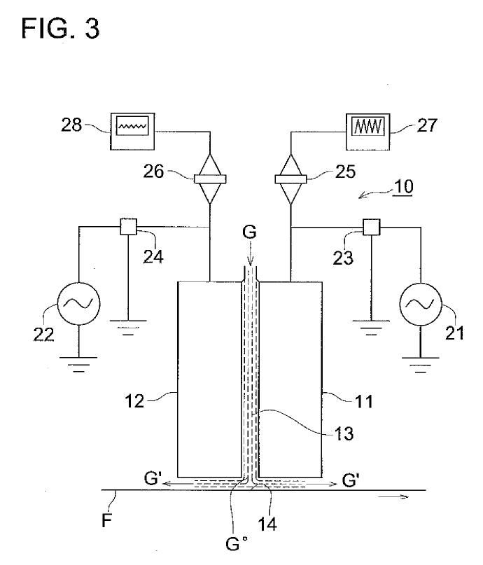

Referring to FIGS. 3 through 5, an example of a plasma film manufacturing apparatus used in the manufacture of the plastic optical element with a gas barrier film of the invention will be explained below.

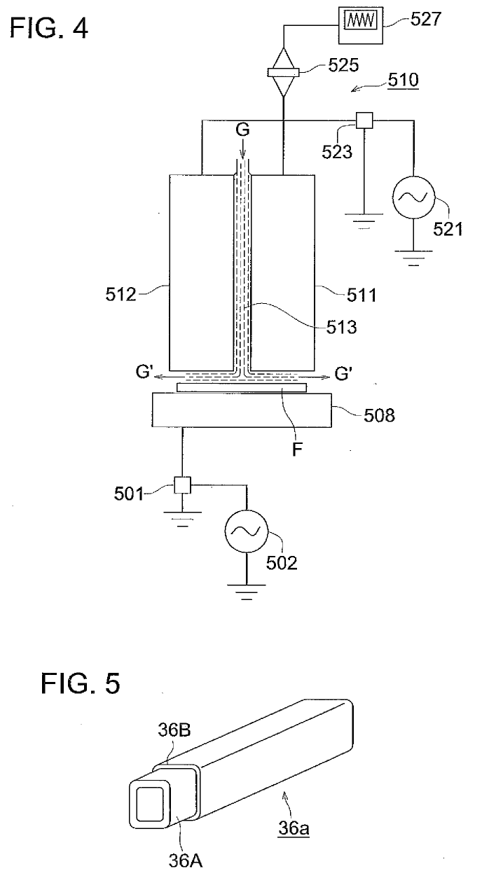

In the plasma discharge processing apparatus shown in FIGS. 3 and 4, a material gas containing the aforementioned metal, a decomposition gas and a discharge gas easy to be in a plasma state mixed with those reaction gases are properly selected, and then introduced into a plasma discharge generation device from a gas supply means, whereby the aforementioned ceramic layer can be produced.

As described above, examples of the discharge gas include a nitrogen gas and/or Group XVIII element of the Periodic Table exemplified by helium, neon, argon, krypton, xenon and radon. Of these elements, nitrogen, helium, and argon are preferred and nitrogen is more preferred in view of low cost.

FIG. 3 shows a schematic view of an example of an atmospheric pressure plasma discharge processing apparatus of jet type used in the invention. It comprises a gas supply means and an electrode temperature regulating means (each not illustrated), in addition to a plasma discharge processing device and an electric field application means having two power sources.

The plasma discharge processing apparatus 10 has opposing electrodes formed of a first electrode 11 and a second electrode 12. An electric field is applied across the opposing electrodes in which a first high-frequency electric field of frequency ω1, electric field intensity V1 and current I1 is applied to the first electrode 11 through the first power source 21 and a second high-frequency electric field of frequency ω2, electric field intensity V2 and current I2 is applied to the second electrode 12 through the second power source 22. The first power source 21 can apply high frequency field intensity higher than that of the second power source 22 (V1>V2). Further, the first power source 21 can apply frequency lower than the second power source 22, i.e., the first frequency ω1 is lower than the second frequency ω2.

The first filter 23 is installed between the first electrode 11 and first power source 21, and is designed to facilitate flow of current from the first power source 21 to the first electrode 11. The current from the second power source 22 is grounded and designed to hinder flow of current from the second power source 22 to the first power source 21.

The second filter 24 is installed between the second electrode 12 and second power source 22, and is designed to facilitate flow of current from the second power source 22 to the second electrode. The current from the first power source 21 is grounded and designed to hinder flow of current from the first power source 21 to the second power source.

Gas G is fed to a space (discharge space) 13 between the opposing electrodes of the first electrode 11 and second electrode 12 from a gas supply means as shown in FIG. 4 described later. Then, high frequency electric field is applied from the first electrode 11 and second electrode 12 to cause discharge, whereby gas G is in a plasma state and jetted onto the lower side of the opposing electrodes (the lower side of the page), so that a processing space formed from the bottom surface of the opposing electrodes and a substrate is filled with the gas G° in the plasma state. A thin layer is formed around the processing position 14 on the substrate F transported from the preceding process. During the thin layer formation, the electrodes are heated or cooled by a medium coming through the tube from the electrode temperature regulating means as shown in FIG. 4 described later. Physical properties and composition of the formed thin layer may vary depending on the temperature of the substrate during the plasma discharge processing, and therefore, appropriate control is desired. An insulating material such as distilled water or oil is preferably used as the medium for temperature regulation. During plasma discharge processing, the temperature inside the electrode is preferably regulated to ensure uniform temperature in order to minimize uneven temperature of the substrate in the transverse and longitudinal directions.

A plurality of jet type atmospheric pressure plasma discharge processing apparatuses are arranged in contact with each other in series, and gas in the same state of plasma can be generated simultaneously. This allows repeated processing and high-speed processing. When gases in a different plasma state of plasma are jetted from those apparatuses, thin layers different from each other can be laminated.

FIG. 4 is a schematic diagram showing an example of an atmospheric pressure plasma discharge processing apparatus used in the invention wherein a substrate is processed between opposing electrodes.

The atmospheric pressure plasma discharge processing apparatus in the present invention comprises at least a plasma discharge processing device 510, an electric field application means having two power sources 502 and 521, a gas supply means (not illustrated) and an electrode temperature regulating means (not illustrated).

FIG. 4 shows that plasma discharge is carried out in a space (discharge space) between the opposing electrodes formed from a stage electrode (a first electrode) 508 and a fixed prismatic electrode group (second electrode) 511 and 512 whereby a substrate is subjected to plasma discharge processing to form a thin layer.

An electric field is applied across the opposing electrodes formed of a stage electrode (first electrode) 508 and a fixed prismatic electrode group (second electrode) 511 and 512, in which a first high-frequency electric field of frequency ω1, electric field intensity V1 and current I1 is applied to the stage electrode (first electrode) 508 through the first power source 502 and a second high-frequency electric field of frequency ω2, electric field intensity V2 and current I2 is applied to the fixed prismatic electrode group (second electrode) 511 and 512 through the second power source 521.

The first filter 501 is installed between the stage electrode (first electrode) 508 and first power source 502, and is designed to facilitate flow of current from the first power source 502 to the first electrode. The current from the second power source 521 is grounded and designed to hinder flow of current from the second power source 521 to the first power source. The second filter 523 is installed between the fixed prismatic electrode group (second electrode) 511 and 512 and second power source 521, and is designed to facilitate flow of current from the second power source 521 to the second electrode. The current from the first power source 502 is grounded and designed to hinder flow of current from the first power source 502 to the second power source.

In the present invention, the stage electrode 508 can be used as the second electrode, and the fixed prismatic electrode group (second electrode) 511 and 512 as the first electrode. The first power source is connected to the first electrode, and the second power source is connected to the second electrode. It is preferred that the first power source can apply high frequency field intensity higher than that of the second power source (V1>V2). Further, the power sources have capacity to provide the relationship represented by ω1<ω2.

The current is preferably I1<I2. The current I1 of the first high frequency electric field is preferably from 0.3 to 20 mA/cm², and more preferably from 1.0 to 20 mA/cm². The current I2 of the second high frequency electric field is preferably from 10 to 100 mA/cm², and more preferably from 20 to 100 mA/cm².

Gas G generated in the gas generation device of the gas supply means is fed to a plasma discharge processing vessel from a gas inlet while controlling the flow rate.

A substrate from the preceding process is transported to a space between the stage electrode (first electrode) 508 and the fixed prismatic electrode group (second electrode) 511 and 512, while maintained on the stage electrode. Electric field is applied to both the stage electrode (first electrode) 508 and the fixed prismatic electrode group (second electrode) 511 and 512 so that discharge plasma is generated in a space (discharge space) between the opposing electrodes. The substrate is transported while being supporting on the stage electrode is subjected to gas in the plasma state to form a thin layer on the substrate. The substrate exits from the discharge space and transported to the next process while maintained on the stage electrode.

The exhaust gas G′ is discharged from an exhaust outlet.

In order to heat or cool the stage electrode (first electrode) 508 and the fixed prismatic electrode group (second electrode) 511 and 512 during the thin layer formation, a medium whose temperature has been regulated by an electrode temperature regulating means is sent to both electrodes by a pump P through a tube so that temperature is regulated from inside the electrodes.

FIG. 5 is a perspective view representing an example of the structure of a prismatic electrode comprising a conductive metallic base material covered with a dielectric.

In FIG. 5, the prismatic electrode 36a is made of a conductive metallic base material 36A covered with the dielectric 36B. The electrode is in the form of a metallic pipe serving as a jacket and is structured to adjust temperature during discharge processing. A medium for temperature regulation (water or silicone oil) is circulated to control the electrode surface temperature during plasma discharge processing.

A plurality of prismatic electrodes are arranged on the stage electrode. The discharge area of the prismatic electrodes is expressed by the total area of the surface of all the prismatic electrodes, the surface opposing the stage electrode 35.

The prismatic electrode 36a shown in FIG. 5 can be a cylindrical electrode. As compared with the cylindrical electrode, the prismatic electrode has the effect of expanding electric discharge range (discharge area), which is preferably used in the present invention.

In FIG. 5, the prismatic electrode 36a is one obtained by a method in which after ceramic as dielectric 36B is sprayed onto the conductive metallic base material 36A, sealing treatment is carried out using a sealing material of an inorganic compound. The thickness of the ceramic dielectric can be about 1 mm on one side. Alumina and silicon nitride are preferably used as the ceramic to be sprayed. In particular, alumina is more preferably used since it can be easily processed. The dielectric layer can be a dielectric provided by lining treatment wherein inorganic material is provided by lining. The same processing as above applies to the stage electrode.

The conductive metallic base materials 35A and 36A include a metal such as a titanium metal or titanium alloy, silver, platinum, stainless steel, aluminum or iron; a composite material of iron and ceramic; and a composite material of aluminum and ceramic. The titanium metal or titanium alloy is preferred for the reasons discussed later.

When a dielectric is provided on the surface of one of the electrodes, the distance between the opposing first and second electrodes is defined as the minimum distance between the aforementioned dielectric surface and the conductive metallic base material surface of the other electrode. When a dielectric is provided on the surface of both electrodes, the distance is defined as the minimum distance between the both dielectric surfaces. The distance is determined consideration a thickness of the dielectric provided on the conductive metallic base material, electric field intensity to be applied, and an object of using plasma. In order to ensure uniform electric discharge, the distance is preferably from 0.1 to 20 mm, and more preferably from 0.2 to 2 mm.

The details of the conductive metallic base material and dielectric preferably used in the present invention will be described later.

The following commercially available products are used as the first power source (high frequency power source) installed on the atmospheric pressure plasma discharge processing apparatus in the present invention:

| Power | | | | |
|---|---|---|---|---|
| source | Manufacturer | Frequency | | Product name |
| A1 | Shinko Electric | 3 | kHz | SPG3-4500 |
| A2 | Shinko Electric | 5 | kHz | SPG5-4500 |
| A3 | Kasuga Electric | 15 | kHz | AGI-023 |
| A4 | Shinko Electric | 50 | kHz | SPG50-4500 |
| A5 | Heiden Research | 100 | kHz* | PHF-6k |
| | Laboratory | | | |
| A6 | Pearl Industry | 200 | kHz | CF-2000-200k |
| A7 | Pearl Industry | 400 | kHz | CF-2000-400k |

Any of them can be used.

The following commercially available products can be used as the second power source (high frequency power source):

| Power | | | | |
|---|---|---|---|---|
| source | Manufacturer | Frequency | | Product name |
| B1 | Pearl Industry | 800 | kHz | CF-2000-800k |
| B2 | Pearl Industry | 2 | MHz | CF-2000-2M |
| B3 | Pearl Industry | 13.56 | MHz | CF-5000-13M |
| B4 | Pearl Industry | 27 | MHz | CF-2000-27M |
| B5 | Pearl Industry | 150 | MHz | CF-2000-150M |

Any of them can be preferably used.

Of the aforementioned power sources, the ones marked with an asterisk indicate an impulse high frequency power source (100 kHz in the continuous mode) manufactured by Heiden Research Laboratory. Others are high frequency power sources capable of applying only the continuous sinusoidal wave.

In the present invention, it is preferred that the atmospheric pressure plasma discharge processing apparatus employs electrodes capable of maintaining uniform and stable electric discharge state during application of the aforementioned electric field.

In the present invention, for the electric power to be applied between opposing electrodes, an electric power (output density) of 1 W/cm² or more is applied to the second electrode (the second high-frequency electric field). Then, discharge gas is excited to generate plasma and to afford energy to a thin layer forming gas, whereby a thin layer is formed. The upper limit value of electric power applied to the second electrode is preferably 50 W/cm², and more preferably 20 W/cm². The lowest limit value is preferably 1.2 W/cm². It should be noted, however, that discharge area (cm²) refers to the electrode area range wherein electric discharging occurs.

When an electric power (output density) of 1 W/cm² or more is applied to the first electrode (first high-frequency electric field), the output density can be improved while uniformity of the second high-frequency electric field is maintained. This generates further uniform and high-density plasma and ensures further increase in the film making speed and further improvement of the layer quality. The electric power is preferably 5 W/cm² or more. The upper limit value of the electric power applied to the first electrode is preferably 50 W/cm².

There is no particular restriction to the waveform of the high-frequency electric field. There are a continuous sinusoidal wave-like continuous oscillation mode called a continuous mode, and a continuous oscillation mode for performing intermittent ON/OFF operations called a pulse mode. Either of them can be used. The continuous sinusoidal wave is preferably used at least on the second electrode (second high-frequency electric field) in order to produce a more dense and high-quality layer.

An electrode used in the thin layer forming method employing atmospheric pressure plasma described above is required to meet severe working conditions in view of both structure and performance. To meet this requirement, an electrode is preferably made of a metallic base material covered with a dielectric.

In the dielectric-covered electrode used in the present invention, metallic base materials and dielectrics whose characteristics conform to each other are preferably used. One of these characteristics is a combination of a metallic base material and a dielectric such that the difference in the linear thermal coefficient of expansion between the metallic base material and the dielectric is 10×10⁻⁶/° C. or less. This difference is preferably 8×10⁻⁶/° C. or less, more preferably 5×10⁻⁶/° C. or less, and still more preferably 2×10⁻⁶/° C. or less. The linear thermal coefficient of expansion herein referred to is a physical property specific to a known material.

The following shows a combination of a conductive metallic base materials and a dielectric wherein the difference in the linear thermal coefficient of expansion falls within the aforementioned range:

1: The metallic base material is made of pure titanium or titanium alloy, and the dielectric is a ceramic spray coating.

2: The metallic base material is made of pure titanium or titanium alloy, and the dielectric is a glass lining.

3: The metallic base material is made of stainless steel, and the dielectric is a ceramic spray coating.

4. The metallic base material is made of stainless steel and the dielectric is a glass lining.

5: The metallic base material is made of a composite material of ceramic and iron, and the dielectric is a ceramic spray coating.

6: The metallic base material is made of a composite material of ceramic and iron, and the dielectric is a glass lining.

7: The metallic base material is made of a composite material of ceramic and aluminum, and the dielectric is a ceramic spray coating.

8: The metallic base material is made of a composite material of ceramic and aluminum, and the dielectric is a glass lining.

From the viewpoint of the difference in linear thermal coefficient of expansion, the aforementioned items 1, 2 and 5 through 8 are preferred. Item 1 is especially preferred.

In the present invention, from the viewpoint of the aforementioned characteristics, titanium or titanium alloy is preferably used as the metallic base material. When the titanium or titanium alloy is used as a metallic base material, and the aforementioned material is used as a dielectric, it is possible to ensure a long-term use under severe conditions, free from deterioration of the electrode, cracks, peeling or separation.

As an atmospheric pressure plasma discharge processing apparatus applicable to the present invention is used the atmospheric pressure plasma discharge processing apparatuses disclosed in Japanese Patent O.P.I. Publication Nos. 2004-68143 and 2003-49272, and WO 02/48428, in addition to those described above.

### EXAMPLES

Next, the invention will be explained employing examples, but the invention is not limited thereto.

### Example 1

Plasma discharge processing was performed using the stage electrode type discharge processing apparatus shown in FIG. 4, and a ceramic layer was formed on a substrate described below. In the discharge processing apparatus, a plurality of rod-like electrodes were arranged facing the stage electrode in parallel with the transporting direction of the substrate in such a way that materials (discharge gas, reaction gas 1, 2 described later) and electric power can be supplied to each electrode.

The dielectric for coating each electrode, together with the opposing electrode, was coated on the ceramic spray electrode to a thickness of 1 mm on one side. After coating, the gap between the electrodes was set to 1 mm. Further, the base metal coating the dielectric was designed as a stainless steel jacket having a cooling function by coolant. Electrode temperature was controlled by coolant during the process of discharging. The light source used in this case was a high frequency power source manufactured by Applied Electrical Equipment (80 kHz), and a high frequency power source manufactured by Pearl Industries (13.56 MHz) Other conditions are as described below;

### <Barrier Processing>

Samples Nos. 1 through 5 as plastic optical elements with a gas barrier film were prepared under the following layer forming conditions while changing the power of a high frequency power source for ceramic layer formation.

In the following process, an adhesion layer was provided in addition to the ceramic layer (film) in the present invention, while changing the formation conditions.

### <Ceramic Layer>

### Discharge gas: N₂ gas

Reaction gas 1: Oxygen gas of 5% by volume based on all gas
Reaction gas 2: Tetraethoxy silane (TEOS) of 0.1% by volume based on all gas
Power of low frequency power source: 10 W/cm² at 80 kHz
Power of high frequency power source: Changed from 1 to 10 W/cm² at 13.56 MHz
Thickness of ceramic layer: 5 nm

The ceramic layer of Samples Nos. 1 through 5 had a composition of SiO₂. Sample Nos. 1, 2, 3, 4 and 5 had a density of 2.07, 2.11, 2.13, 2.18, and 2.20, respectively.

### <Adhesion Layer>

### Discharge gas: N₂ gas

Reaction gas 1: Oxygen gas of 1% by volume based on all gas
Reaction gas 2: Tetraethoxy silane (TEDS) of 0.5% by volume based on all gas
Power of low frequency power source: 10 W/cm² at 80 kHz
Power of high frequency power source: 5 W/cm² at 13.56 MHz
Thickness of adhesion layer: 20 nm

The adhesion layer had a composition of SiO_{1.48} C_{0.96}, and a density of 2.02.

### <Substrate>

A substrate sample in the form of pellet with a diameter of 5 mmφ and a thickness of 1 mm was prepared employing EVOH resin (EVAL resin F101 produced by Kuraray Co., Ltd.).

The resulting substrate sample was subjected to barrier processing as described above.

### <Gas Barrier Property Measuring Method>

Fifty pieces of each of samples subjected to barrier processing were prepared as one set. With respect to each sample, moisture absorption weight per entire surface area was determined in terms of g/m²/day according to a gravimetric method (40° C. and 90% RH) based on JTIS Z0208, and evaluated as a measure of gas barrier property.

### Conditions

### <Measurement of Density Ratio>

A silicon substrate as density (ρb) of the bulk ceramic (silicon oxide: SiO₂) was subjected to baking at 1100° C. to form on the surface a thermal oxidation film with a thickness of 100 nm. The density of the thermal oxidation film was 2.20, determined according to X-ray reflectivity measurement. This value was regarded as density (ρb) of the bulk silicon oxide film.

Further, the density (ρf) of the ceramic layer (silicon oxide layer) of each of the samples, which were formed while changing the electric power of the high frequency power source, was determined according to X-ray reflectivity measurement in the same manner as above.

In the X-ray reflectivity measurement, the Model MXP21 produced by MacScience Inc. was used as a measuring instrument. Employing copper as an X-ray source target, the instrument was operated at a voltage of 42 kV and at a current of 500 mA. A multi-layer film parabola mirror was used as the incident monochrometer. The incident slit was 0.05 mm×5 mm, and the light receiving slit was 0.03 mm×20 mm. According to a 2θ/θ scanning process, measurement was conducted by an FT method in the range of 0 to 5° at a step width of 0.005°, 10 seconds per step to obtain a reflectivity curve. Curve fitting was applied to the reflectivity curve, using Reflectivity Analysis Program Ver. 1 produced by MacScience Inc., and parameters were determined in such a way that the residual sum of squares between the measured value and the fitting curve is minimized. Then, the density of each ceramic layer was obtained from each parameter.

The density ratio (ρf/ρb) was obtained for each of the samples from the density (ρf) of the ceramic (silicon oxide) layer formed according to the atmospheric pressure plasma CVD method and the density (ρb) of the bulk ceramic (silicon oxide) layer.

TABLE 1

| | High frequency | Density | Moisture vapor | |
|---|---|---|---|---|
| Sample | power | ratio | barrier property | |
| No. | (w/cm²) | (ρf/ρb) | (g/m²/day) | Remarks |
| 1 | 1 | 0.94 | 7.3 | Comparative |
| | | | | example 1 |
| 2 | 3 | 0.96 | <0/1 | Inventive |
| 3 | 5 | 0.97 | <0/1 | Inventive |
| 4 | 7 | 0.99 | <0/1 | Inventive |
| 5 | 10 | 1 | <0/1 | Inventive |

In Table 1, the unit of the vapor permeability is g/m²/day. Table 1 reveals that samples having a density ration falling within the range of the invention provide high moisture vapor barrier property.

### Example 2

A layer having the following layer structure was formed on the substrate according to the same procedure in the same manner as in Example 1, using a Plasma CVD apparatus, Model PD-270STP produced by Samco Inc.

Each layer in Samples Nos. 6 through 10 was formed as follows:

### <Ceramic Layer>

Oxygen pressure: Gas pressure was changed between 13.3 and 133 Pa as shown in Table 2.
Reaction gas: Tetraethoxy silane (TEOS) at 5 sccm (standard cubic centimeter per minute)

### Power: 100W at 13.56 MHz

Retained substrate temperature: 120° C.

Samples Nos. 6 through 10 had a ceramic layer with a composition of SiO₂, and had a density of 2.13.

### <Adhesion Layer>

Adhesion layer was formed in the same manner as the above ceramic layer formation conditions, provided that power application was reversed, the electrode on the side supporting the substrate being grounded and high frequency power being applied to the opposed electrode. The adhesion layer of each sample had a composition of SiO_{1.48}C_{0.96}. Sample Nos. 6, 7, 8, 9 and 10 had a density of 2.08, 2.05, 2.02, 1.98, and 1.96, respectively.

With respect to each of the thus obtained plastic optical element with a gas barrier film, the density ratio (ρf/ρb) of the ceramic layer density to the bulk ceramic layer density was obtained in the same manner as above, and gas barrier property was evaluated in the same manner as in Example 1. Furthers residual stress was evaluated.

### <Residual Stress Evaluation Procedure>

A ceramic layer with a thickness of 1 μm was formed as a barrier layer on a quartz glass having a thickness of 100 μm, a width of 10 mm and a length of 50 mm. The residual stress was determined according to a thin layer physical property evaluation apparatus, MH4000 produced by NEC-Sanei Inc. (MPa). Sample Nos. 1 through 5 prepared in Example 1 was determined for a residual stress (MPa) in the same manner as above, and all of the samples had a residual stress of 0.9 MPa.

With respect to the gas barrier property, a gas barrier property at an initial stage and that after subjected to repeated thermo processing were determined. In the repeated thermo processing, the sample was allowed to stand at 23° C. and at 55% RH for 24 hours, and subjected to temperature change ranging from −40 to 85° C. which was repeated 300 times in 30 minutes. Thus, a moisture vapor barrier property was evaluated.

The results are shown in the following Table. It should be noted that “-” in the column of gas pressure in Table 3 indicates atmospheric pressure.

TABLE 2

| | | | | Moisture vapor | | |
|---|---|---|---|---|---|---|
| | | | | barrier property | | |
| | | | | (g/m²/day) | | |
| | | | | | After | |
| Sam- | Gas | Density | Residual | | repeated | |
| ple | pressure | ratio | stress | | thermo | |
| No. | (Pa) | (ρf/ρb) | (MPa) | Initial | processing | Remarks |
| 6 | 22.6 | 0.97 | 120 | <0.1 | 0.3 | Comparative |
| | | | | | | example 2 |
| 7 | 39.9 | 0.97 | 80 | <0.1 | <0.1 | Inventive |
| 8 | 53.2 | 0.97 | 50 | <0.1 | <0.1 | Inventive |
| 9 | 60.0 | 0.97 | 15 | <0.1 | <0.1 | Inventive |
| 10 | 63.8 | 0.97 | 5 | <0.1 | <0.1 | Inventive |
| 5 | — | 1 | 0.9 | <0.1 | <0.1 | Inventive |

In Table 2, the unit of the vapor permeability is g/m²/day. Table 2 reveals that samples having a stress falling within the range of the invention provide high moisture vapor barrier property, even after subjected to repeated thermo processing.

### Example 3

Sample Nos. 11 through 20 were prepared in the same manner as in Sample Nos. 1 through 10 described above, respectively, except that a resin substrate as described later was used instead of the substrate.

Inorganic layer comprised of Si and O having a thickness of 100 nm was formed on the resin substrate by sputtering according to a method disclosed in Patent Document 3 (Japanese Patent O.P.I. Publication Nos. 2004-361732). In sputtering, a silicon plate was employed as a target, and gas to be introduced was Ar/O₂ (=45/55 by sccm), layer formation pressure 0.7 Pa, and discharge electric power 2 kW.

Then, a polyurethane-based anchor coat (product of Mitsui Takeda Chemicals, Inc.; main agent, Takelac A-310; curing agent, Takenate A-3) was applied to the surface of the inorganic layer 14 and dried; thereafter, using Saran Latex of ASAHI KASEI CORP., a polyvinylidene chloride film was formed as an organic layer in a thickness of about 800 nm.

The anchor coat and the polyvinylidene chloride film were formed according to dip coating, followed by drying at 70° C.

The resulting substrate was aged for 3 days at 35° C. and at 20% RH in which the entire surface of the substrate was covered with the multi-layered film comprising the inorganic layer and the organic layer. Thus, Sample No. 21 was prepared.

Next, the entire surface of the substrate was dip coated with SolGard primer produced by Nippon Dacro Shamrock Co., Ltd and dried at 90° C. for 20 minutes to form a primer coat which in turn was dip coated with SolGard NP730. By subsequent curing at 120° C. for 1 hour, a Si/O inorganic layer was formed in a thickness of about 300 nm (i.e., sol-gel process).

An organic layer was formed on the surface of the inorganic layer by applying a polyvinylidene chloride film in the same manner as in Sample No 21 above, in which the entire surface of the substrate was covered with the multi-layered film comprising the inorganic layer and the organic layer. Thus, Sample No. 22 was prepared.

### <Resin Substrate>

A cycloolefin resin APEL 5014 was added with an anti-oxidant, a thermal stabilizer, a light stabilizer, a weather stabilizer, an Ultraviolet absorbent, a near-infrared absorbent, a lubricant and a plasticizer in a predetermined amount and melt-kneaded. The melt-knead was conducted at a rate of 100 rpm for 10 minutes under nitrogen atmosphere, employing a LABO PLASTMILL KF-6V, and degassing was conducted under reduced pressure of 2.66 kPa for 2 minutes immediately before kneading.

### (Preparation of Molding)

The resulting material was pressed at 160° C. under a reduced pressure of 1.33 kPa to obtain a molding with a diameter of 11 mm and a thickness of 3 mm. The surface of the molding was polished and provided with a gas barrier film.

### <Formation of Anti-Reflection Layer)

An anti-reflection layer was provided on Sample Nos. 11 through 22 and Sample No. 23 (employing a substrate without barrier processing), employing a sheet-feed type sputtering apparatus SME-200E, produced by ULVAC, Inc.

A TiO₂ layer and a SiO₂ layer were provided on the substrate in that order as the anti-reflection layer was prepared in a predetermined thickness.

The resulting plastic optical element samples with the anti-reflection layer were allowed to stand for 30 minutes under a condition of 80° C. and 90% RH and then for 30 minutes under a condition of 80° C. and 20% RH. This process was repeated, and time taken until cracks generate was determined. Cracks generated were observed according to an optical microscope.

TABLE 3

| | Gas | Density | Residual | Time taken until | |
|---|---|---|---|---|---|
| Sample | pressure | ratio | stress | cracks generate | Re- |
| No. | (Pa) | (ρf/ρb) | (MPa) | (hr) | marks |
| 11 | — | 0.94 | 0.9 | 48 | Comp. |
| 12 | — | 0.96 | 0.9 | >3000 | Inv. |
| 13 | — | 0.97 | 0.9 | >3000 | Inv. |
| 14 | — | 0.99 | 0.9 | >3000 | Inv. |
| 15 | — | 1 | 0.9 | >3000 | Inv. |
| 16 | 22.6 | 0.97 | 120 | 72 | Comp. |
| 17 | 39.9 | 0.97 | 80 | 1500 | Inv. |
| 18 | 53.2 | 0.97 | 50 | 2000 | Inv. |
| 19 | 60.0 | 0.97 | 15 | >3000 | Inv. |
| 20 | 63.8 | 0.97 | 5 | >3000 | Inv. |
| 21 | | 0.98 | 1800 | 24 | Comp. |
| 22 | — | 0.88 | 5400 | 12 | Comp. |
| 23 | — | — | — | 24 | Comp. |

Comp.: Comparative,
Inv.: Inventive

The inventive plastic optical elements with the gas barrier film in the invention are difficult to produce cracks, providing excellent durability. Further, the inventive plastic optical elements do not produce white turbidity even after long-term use.

1. A plastic optical element with a gas barrier film comprising a resin substrate and provided thereon, at least one ceramic layer, the residual stress of the ceramic layer being from 0.01 to 100 MPa in terms of compression stress, and a density ratio Y (=ρf/ρb) satisfying the following inequality:
1≧Y>0.95
wherein ρf represents a density of the ceramic layer, and ρb represents a density of a layer which has the same composition ratio as the ceramic layer and which has been formed by thermal oxidation or thermal nitridation of a metal which is a base material of the ceramic layer.

2. The plastic optical element with a gas barrier film of claim 1, wherein the density ratio Y (=ρf/ρb) satisfies the following inequality:
1≧Y>0.98.

3. The plastic optical element with a gas barrier film of claim 1, wherein the residual stress of the ceramic layer is from 0.01 to 10 MPa.

4. The plastic optical element with a gas barrier film of claim 1, wherein a material constituting the ceramic layer is silicon oxide, silicon oxide nitride, silicon nitride, aluminium oxide or a mixture thereof.

5. The plastic optical element with a gas barrier film of claim 1, wherein a ceramic layer having a density lower than the ceramic layer is provided between the substrate and the ceramic layer.

6. The plastic optical element with a gas barrier film of claim 1, wherein the plastic optical element with a gas barrier film is a lens.

7. An optical pickup device employing the plastic optical element with a gas barrier film of claim 1.

8. A process of manufacturing a plastic optical element with a gas barrier film comprising a resin substrate and provided thereon, at least one ceramic layer, the process comprising the steps of:
exciting gas containing a thin layer-forming gas under atmospheric pressure or approximately atmospheric pressure by a high frequency electric field to obtain an excited gas; and exposing a resin substrate to the excited gas to form at least one ceramic layer on the resin substrate,
wherein the residual stress of the ceramic layer is from 0.01 to 100 MPa in terms of compression stress, and a density ratio Y (=ρf/ρb) satisfies the following inequality:
1≧Y>0.95
wherein ρf represents a density of the ceramic layer, and ρb represents a density of a layer which has the same composition ratio as the ceramic layer and which has been formed by thermal oxidation or thermal nitridation of a metal which is a base material of the ceramic layer.

9. The process of manufacturing a plastic optical element with a gas barrier film of claim 8, wherein the gas contains a nitrogen gas in an amount of not less than 50% by volume.

10. The process of manufacturing a plastic optical element with a gas barrier film of claim 8, wherein the high frequency electric field is one in which a first high frequency electric field and a second high frequency electric field are superposed, frequency ω2 of the second high frequency electric field is higher than frequency ω1 of the first high frequency electric field, and the following inequality is satisfied:
V1≧IV>V2 or V1>IV≧V2
wherein V1 represents intensity of the first high frequency electric field, V2 represents intensity of the second high frequency electric field, and IV represents intensity at the time discharge begins.

11. The process of manufacturing a plastic optical element with a gas barrier film of claim 10, wherein the output density of the second high frequency electric field is not less than 1 W/cm².

12. The process of manufacturing a plastic optical element with a gas barrier film of claim 8, wherein the resin substrate is maintained by a dielectric.
